(19) United States
(12) Patent Application Publication
(10) Pub. No.: US 2017/0083646 A1
(43) Pub. Date: Mar. 23, 2017

(54) METHOD FOR MODIFYING COMPUTER-BASED MODELING

(71) Applicant: FunctionBay, Inc., Seongnam-si (KR)

(72) Inventors: Seong Ho YANG, Seongnami-si (KR); Jin Hwan CHOI, Seongnami-si (KR); Kyung Chun JANG, Seongnami-si (KR); Sangtae KIM, Seongnami-si (KR)

(21) Appl. No.: 15/242,544

(22) Filed: Aug. 21, 2016

(30) Foreign Application Priority Data
Sep. 22, 2015 (KR) 10-2015-0133791

(51) Int. Cl. G06F 17/50

(52) U.S. Cl. CPC G06F 17/5009

(57) ABSTRACT

Provided is a modeling method including: executing a modeling program; performing a first modeling based on a plurality of entities by using the modeling program, wherein a first entity among the plurality of entities comprises a first parameter and a first value corresponding to the first parameter; parsing a header value, a parameter value, and a modification value corresponding to each field from a data table comprising a header field, a parameter field, and a modification field; modifying the first value of the first entity based on the extracted header value, parameter value, and modification value; and performing a second modeling based on the modified first entity.

### CROSS-REFERENCE TO RELATED APPLICATION(S)

This application claims the benefit under 35 U.S.C. §119(a) of a Korean patent application filed on Sep. 22, 2015 in the Korean Intellectual Property Office and assigned Serial number 10-2015-0133791, the entire disclosure of which is hereby incorporated by reference.

### TECHNICAL FIELD

The present disclosure relates to a computer-based modeling method, and more particularly, to a technique for modifying a model implemented in modeling by utilizing a spreadsheet.

### BACKGROUND

Multi-body dynamics (MBD) modeling means interpreting or simulating the relative motion and force of configuration objects that configure a system, in general, in the case that a plurality of objects move while maintaining the mutual organic relationship.

Computer-aided engineering (CAE), that is, a simulation technique using computer(or software), is utilized in an MBD modeling for performing simulation, verification, and optimization on products, processes, and manufacturing tools. Representative CAE software includes RecurDyn™, NX, ABAQUS, ADAMS, and Simpack. In order to perform MBD modeling, a user is required to learn how to use such CAE software.

A method for implementing MBD modeling without expert knowledge on such CAE software by using spreadsheet such as Microsoft® Excel is disclosed in Korea Patent Application 10-1367398. The contents of the publications are incorporated herein by reference.

In general, even if a model implementation for 3D or specific system is completed through a modeling task, an engineer may perform modifications on a model as changing several parameter values in order to test the stability of a model or detect errors. Even if an inefficiency that inputting a greatly large amount of data is performed repeatedly for modeling under a graphical user interface (GUI) environment or an additional difficult for leaning a programming language to avoid repetitive tasks is greatly resolved through a modeling method using spreadsheet, since parameters that an engineer modifies are mostly fixed in fact but parameters to be modified in a spreadsheet are distributed at different positions, finding and modifying them individually may cause another inconvenience.

Additionally, since numerous modeling task results exist already and a modeling technique using spreadsheet is suggested relatively recently, most of modeling results are accomplished based on existing CAE software. Generating data on an already completed model again based on a spreadsheet in order to modify some parameters in a model completed based on CAE software may also correspond to the inefficiency.

For example, a modeling environment using a GUI shown in FIG. 1 may be considered. The modeling environment shown in FIG. 1 is to rearrange contents outputted to one window and/or pop-up window, for convenience of description.

FIG. 1 may correspond to a Four-bar Linkage system modeling. That is, FIG. 1 may correspond to a modeling of a system 10 including three link bodies (for example, Body_Link1 11, Body_Link2 12, and Body_Link3 13) and a sphere (for example, Body_Sphere 14) connected to a link body. In a modeling for rotating the system 10 counterclockwise by giving a predetermined initial velocity, in order to modify a parameter value corresponding to an initial velocity of a link body (for example, Body Link1 11) that contacts a sphere (for example, Body_Sphere 14) fixed at the ground, the following tasks are required. (1) Find the link body 11 connected to the sphere 14 from a database window 20 (2) Bring up a properties window 30 through double click (3) Bring up a window (for example, Body Initial Velocity) for setting an initial velocity by selecting an initial velocity item (4) Input an appropriate value, for example, 5, as a rotational velocity in a z-axis direction.

A system engineer may perform modeling repeatedly as variously changing a parameter value in order to consider various environments. However, as described above, simple parameter modifications may require inefficient user inputs several times.

### SUMMARY

Accordingly, an aspect of the present disclosure is to provide a method for performing a modification task on a modeling efficiently. Another aspect of the present disclosure is to provide a modeling modifying method that is commonly applied to both a model generated in an existing GUI method and a model generated in a spreadsheet method.

In accordance with an aspect of the present disclosure, a modeling method includes: executing a modeling program; performing a first modeling based on a plurality of entities by using the modeling program, wherein a first entity among the plurality of entities comprises a first parameter and a first value corresponding to the first parameter; parsing a header value, a parameter value, and a modification value corresponding to each field from a data table comprising a header field, a parameter field, and a modification field; modifying the first value of the first entity based on the extracted header value, parameter value, and modification value; and performing a second modeling based on the modified first entity.

In accordance with another aspect of the present disclosure, provided is a computer readable recording medium for storing an instruction to perform the method.

### BRIEF DESCRIPTION OF THE DRAWINGS

FIG. 1 is a view illustrating a modification GUI of an MBD modeling using conventional CAE software.

FIG. 2 is a view illustrating an exemplary structure of data table applicable to modeling modification according to an embodiment of the present disclosure.

FIG. 3 is a view illustrating a mapping relationship between a data table for modeling modification and a modeling GUI environment according to an embodiment of the present disclosure.

FIG. 4 is a view illustrating a modeling modifying method using a reference between data tables according to an embodiment of the present disclosure.

FIG. 5 is a view illustrating an example of a modeling based on a change in parameter value according to an embodiment of the present disclosure.

FIG. 6 is a view illustrating a data table for providing an additional function to modeling modification according to an embodiment of the present disclosure.

FIG. 7 is a view illustrating an exemplary modeling modification UI according to an embodiment of the present disclosure.

FIG. 8 is a view illustrating a modeling modification process according to an embodiment of the present disclosure.

FIG. 9 is a view illustrating an exemplary configuration of an electronic device for performing a modeling modification process according to an embodiment of the present disclosure.

### DETAILED DESCRIPTION

Hereinafter, embodiments of the present disclosure will be described with reference to the drawings.

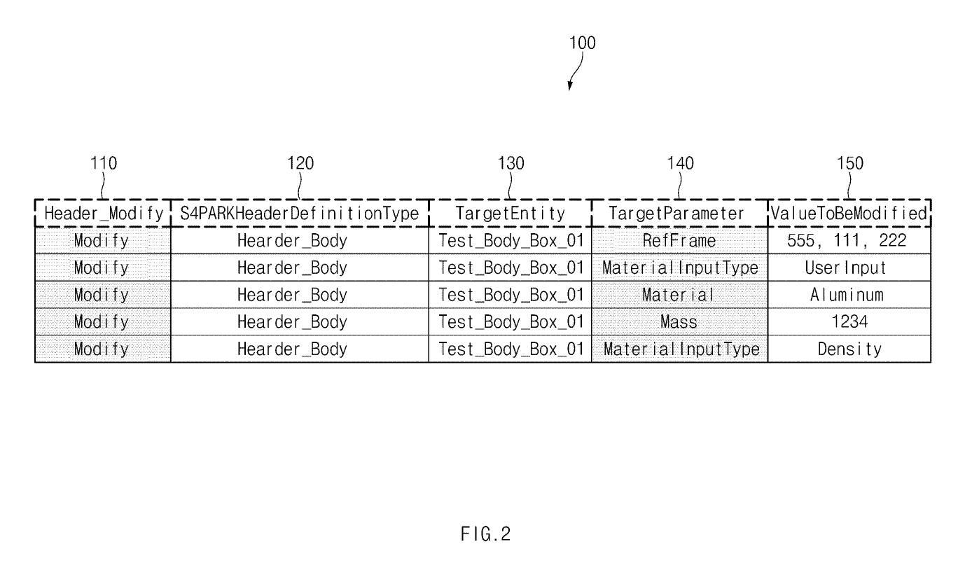

FIG. 2 is a view illustrating an exemplary structure of data table applicable to modeling modification according to an embodiment of the present disclosure.

A dynamic model formed through a modeling program may include a plurality of entities. Herein, an entity, as a unit for configuring a model, may include a component necessary for modeling such as contact or joint in addition a body for forming a system structure.

Each entity may have various characteristics defined according to an entity. For example, each entity may have values such as the size, length, color, material, coordinates, and speed of an entity.

In the case of a completed modeling, it may include a plurality of entities according to the complexity of a system. In a state that a system is not changed, that is, an entity is maintained, when a system is studied as a parameter value allocated to an entity is changed, according to an embodiment of the present disclosure, instead of modifying a GUI directly and repeatedly, a data table 100 may be utilized. Even if a system model is a model modeled using a spreadsheet and generated, instead of finding a value to be changed in the entire spreadsheet and inputting each modification value, the data table 100 may be configured with respect to a parameter to be changed.

The data table 100 may include a minimum field necessary for a modification task. That is, it is not necessary to define all parameter values of an entity that is a modification target in order to modify a modeling. Such a convenience has advantages with respect to a model processed in a GUI environment and a model processed using a spreadsheet. That is, in order to process a modification task of a model based on a modeling using a typically described spreadsheet, values of all (required) parameters of an entity that is a modification target are required to be defined in a data structure. If not, a modeling program may return an error value.

The data table 100 may include a plurality of fields and may have a matrix configured with a column having at least one value corresponding to each field. For example, the data table 100 may include a header field 110, an entity type field 120, an entity name field 130, a parameter field 140, and a modification field 150. Herein, the entity type field 120 and the entity name field 130 may be referred to as an entity field simply. Additionally, not all fields listed in the data table 100 of FIG. 2 are required. For example, if a parameter to be modified by only the parameter field 140 is specified, that is, a parameter having a name identical to a value corresponding to the parameter field 140 is unique in a system, the data table 100 may include only the head field 110, the parameter field 140, and the modification field 150. If a parameter identical to a value corresponding to the parameter field 140 is in plurality in a system, an entity name field 130 and/or an entity type field 120 may be additionally included in order for specifying a parameter.

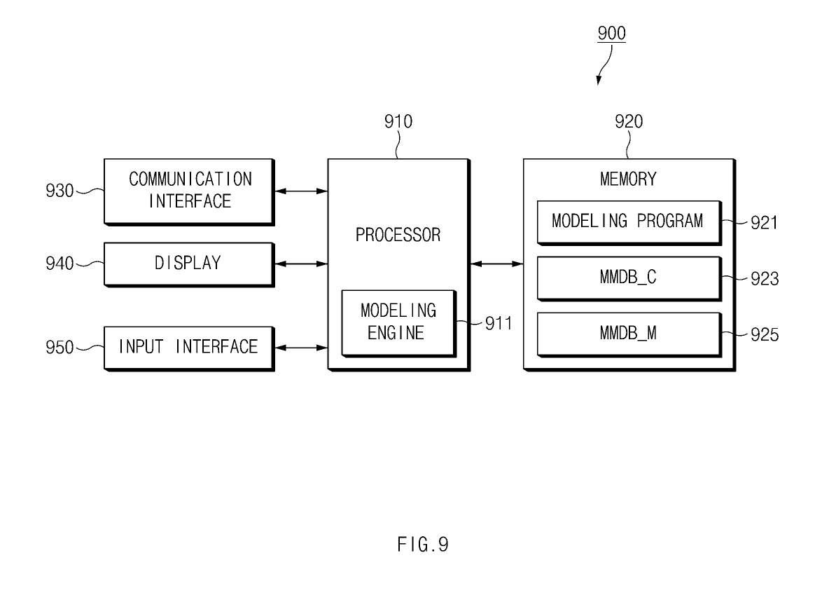

The header field 110 (for example, Header_Modify) may define a header value of a modification mode modeling. For example, in relation to a modeling program executing device (for example, a computing device 900 of FIG. 9), only when a header value corresponding to the header field 110 corresponds to a predefined value, it may be recognized as data for modification. For example, in the example of FIG. 2, only when a header value of the header field 110 is “Modify”, a value of a parameter (for example, “RefFrame”) in the parameter field 140 (for example, TargetParameter) may be replaced with a value (for example, “555”, “111”, and “222”) defined in the modification field 150 (for example, ValueToBeModified). If a header value of the header field 110 is not a specified value (for example, “Modify”), a calculation device may ignore information of a corresponding row or skip it to extract modification information of the next row.

The data table 100 described in this present disclosure includes a data structure configured with a column and a row such as a typical spreadsheet, for example, a spreadsheet or a database provided from MS Excel, OpenOffice™, a document in a web-based table format written in a language html, xml, php, and so on in addition to a data structure stored by software such as one cell of Hancom office provided from Hangul and Computer™, and a text interpreted as a web based spreadsheet provided from Google Docs, a cloud computing based spreadsheet, and a table structure inputted by a tab and enter input. This is exemplary, and the above embodiments do not limit the scope of a data table applied to the present disclosure.

A computing device may specify a system model (for example, a system model 10) to be modified through a modeling program, and a data table (for example, the data table 100) including modification data, or a file including a data table. A computing device may extract a header value, a parameter value, and a modification value corresponding to each parameter from a data table, and allow a modeling program to modify a value of a parameter corresponding to the extracted value to perform a modeling.

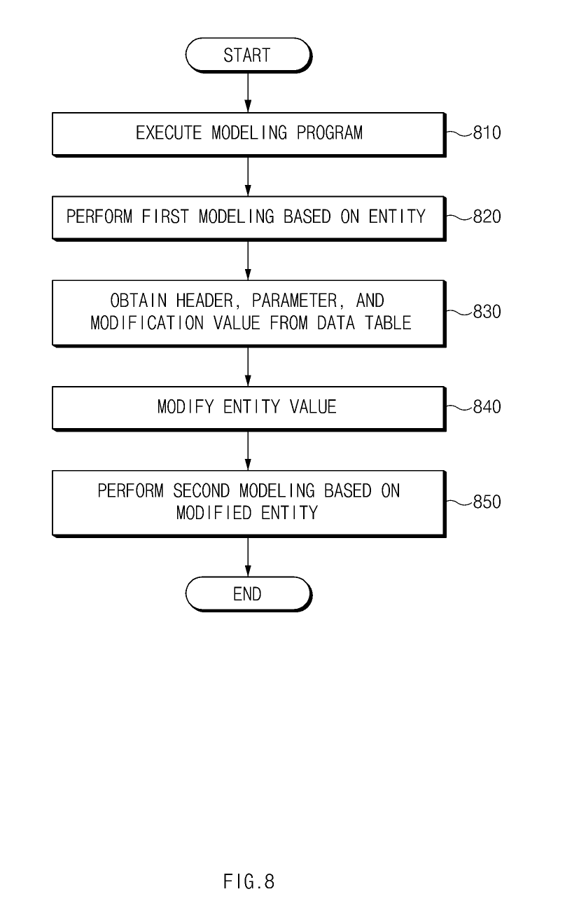

According to an embodiment of the present disclosure, after a parameter included in the data table 100 and a modification value of each parameter are all reflected from top to bottom, a modeling may be performed. For example, after modification values of specified parameters “RefFrame”, “MaterialInputType”, “Material”, “Mass”, and “MaterialInputType”in the parameter field 140 are all applied, a modeling may be performed. However, according to another embodiment of the present disclosure, a task for reflecting a parameter in the data table 100 and a modification value of each parameter by a row unit and performing a modeling may be repeated. For example, after performing a modeling by reflecting a modification value of “RefFrame”, and again after reflecting a modification value of “MaterialInputType”, the next modeling may be performed. Additionally, according to an embodiment of the present disclosure, a modeling may be performed by reflecting all parameter values extracted before a repeated parameter value appears, and a modeling may be performed again by reflecting a repeated parameter value later. For example, after performing a modeling by reflecting modification values of “RefFrame”, “MaterialInputType” (that is, a third row, “UserInput”), “Material”, and “Mass”, a modeling may be performed by reflecting a modification value “Density” of “MaterialInputType” (that is, a sixth row) again. A modeling modification process will be described with reference to FIG. 8.

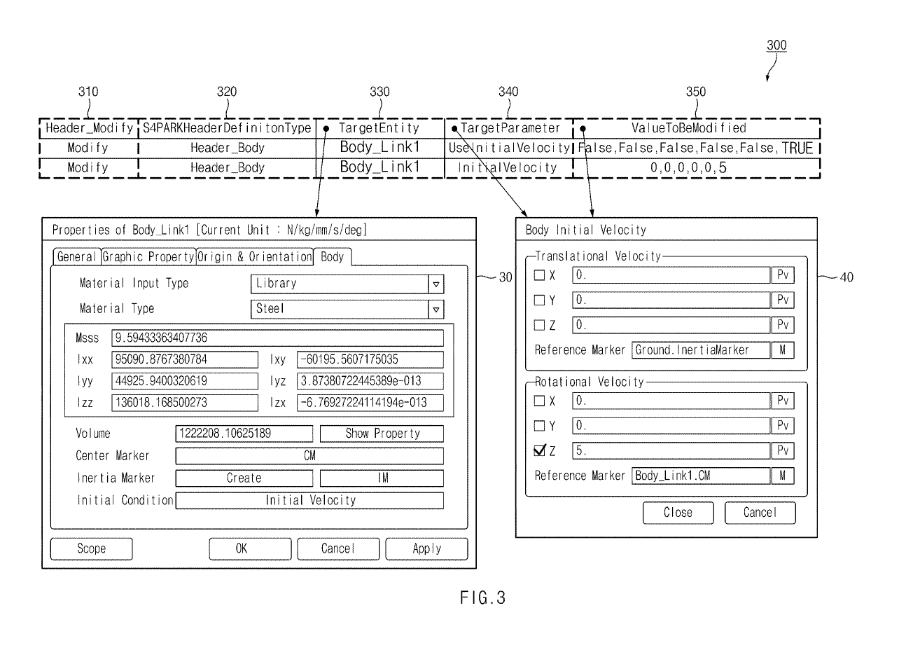

FIG. 3 is a view illustrating a mapping relationship between a data table for modeling modification and a modeling GUI environment according to an embodiment of the present disclosure.

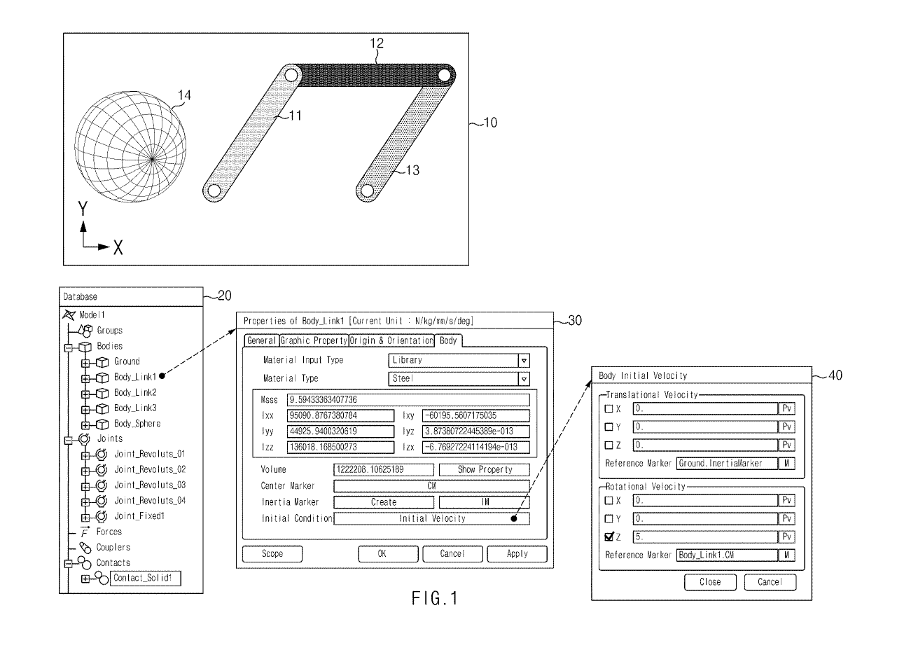

FIG. 3 may correspond to a method for performing a modification through a GUI of the system model 10 shown in FIG. 1 by using the data table 300.

The data table 300 may include a header field 310, an entity type field 320, an entity name field 330, a parameter field 340, and a modification value field 350. The data table shown in FIG. 3 corresponds to a data table for modifying a parameter “Initial Velocity”of an entity “Body_Link1”.

An entity that is a modification target may be determined by an entity field. The data table 300 may define Body_Link1 11 of the system 10 as a modification target entity. That is, a value of a specified parameter in the parameter field 340 among various parameters of Body_Link1 11 displayed on a window 30 may be replaced based on a modification value defined in the modification field 340.

The data table 300, for example, may define two parameters with respect to Body_Link1 11. However, twelve parameter values may be changed actually instead of two. One parameter may have a plurality of values (for example, 3D coordinates, RGB colors, velocity and direction in the case of speed, and coefficient of kinetic friction and coefficient of static friction in the case of resistance), and according to an appropriate method defined in the modification field 350, a plurality of values corresponding to a parameter may be changed. Although parameter values are separated sequentially by using a comma (,) in the example of FIG. 3, a parameter value separating method is not limited thereto. For example, a parameter value may be separated using a slash (/) or a simple spacing. For example, a method for separating an input such as “False/False/False/False/False/TRUE” or “False False False False False TRUE” may be defined.

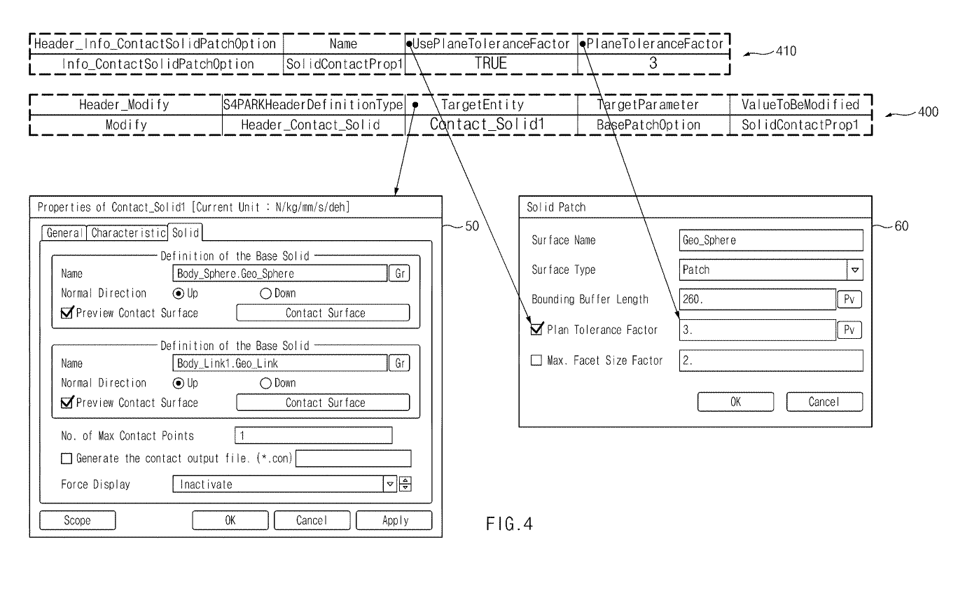

Additionally, in addition, a sub data table is specified in the modification field 350, and a value of a parameter may be changed with a value defined in the sub data table. This allows a frequently used setting to be configured with an additional sub data table. A description relating to this is provided with reference to FIG. 4.

In an example of the data table 300 of FIG. 3, the parameter field 340 includes fields of “UseInitialVelocity” and “InitialVelocity”. The modification field 350 includes “False, False, False, False, False, TRUE” and “0, 0, 0, 0, 0, 5”. A modeling program may extract data of the data table 300, process first five values among six values included in “Initial Velocity” in the parameter of Body_Link1 11 as “not use” (uncheck), process the sixth value as “use” (check), and then, input values of 0, 0, 0, 0, 0, and 5 sequentially. Through this, a system may be modified to have an initial velocity of 5 as a z-axis rotation with respect to Body_Link1 11 connected to the sphere 14.

In the example of FIG. 3, when it is possible that a component parameter “z” of “Rotational Velocity” in the window 40 is specified, the data table 300 may be changed more simply. For example, when the parameter field 340 has a value of “RotationalVelocity(z)” and “RotationalVelocity(z)”is defined to correspond to a z value of the window 40, the modification field 350 may be defined to have a value of “5”. That is, a data table may be configured or modified variously according to modeling software and a parameter used in modeling software, and the present disclosure is not limited to a form suggested in this specification for description.

FIG. 4 is a view illustrating a modeling modifying method using a reference between data tables according to an embodiment of the present disclosure.

Referring to FIG. 4, a data table in a spreadsheet may be in plurality. For example, a data table 400 and a data table 410 may be in one spreadsheet. Of course, according to another embodiment of the present disclosure, the data table 400 and the data table 410 may be defined in different spreadsheets or different file, which are accessible from a modeling program or a computing device for executing a modeling program. For convenience of description, it is assumed and described that all tables exist in the same sheet.

The data table 400 corresponds to a data table defined to a parameter of a “Contact_Solid1” entity. Herein, “Contact_Solid1” may correspond to an entity for defining a contact between the sphere 14 and the link 11 in the system 10. “BasePatchOption”, that is, a modification target parameter, may correspond to a Slid Patch window 60 that is open when a “Contact Surface” item in a “Definition of the Base Solid” area is selected from a specific window 50 of Contact_Solid1, based on a GUI.

In the data table 400, “SolidContactProp1” is defined as a modification value of “BasePatchOption”. Herein, “SolidContactProp1” may correspond to a value for specifying a sub data table including modification data. Based on this, a computing device may extract a sub data table. According to an embodiment of the present disclosure, when a modification value satisfies a specified condition such as a predefined format (for example, including “Prop”) or a predefined value (for example, “SolidContactProp1”), a sub data table may be specified based on a modification value. Additionally, according to another embodiment of the present disclosure, if a modification value is a value that is impossible to be inputted from a parameter or is undefined, a computing device may determine whether a specified sub data table exists based on the modification value. In consideration of the arithmetic operation speed or efficiency, an appropriate method may be applied selectively or in combination.

The sub data table 410 defined by the modification value “SolidContactProp1” may include a sub table head field, a Name Field corresponding or identical to the modification value “SolidContactProp1”, and at least one parameter field. A difference from the data table 400 is that a parameter that is a modification target (for example, UsePlanToleranceFactor and PlaneToleranceFactor) may be specified in the name of a parameter field, and a modification value (for example, TRUE and 3) may be specified in a value of a parameter field. However, according to another embodiment of the present disclosure, it is apparent to those skilled in the art that a structure of the sub data table 410 may be defined in the format of the data table 400. In the embodiment of FIG. 4, the sub data table 410, for example, may set the value to 3 as using (or checking) a Plain Tolerance Factor on the Solid Patch window 60.

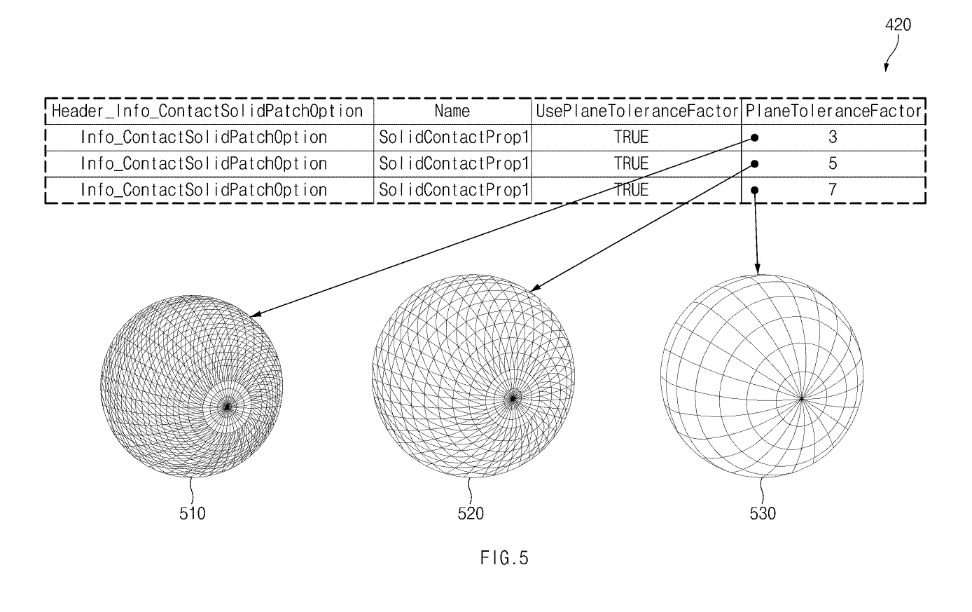

FIG. 5 is a view illustrating an example of a modeling based on a change in parameter value according to an embodiment of the present disclosure.

The embodiment of FIG. 5 may correspond to a case that a system model is modified by applying the sub data table 420 where a value of the Plain Tolerance Factor is modifiable variously in the above-described embodiment of FIG. 4.

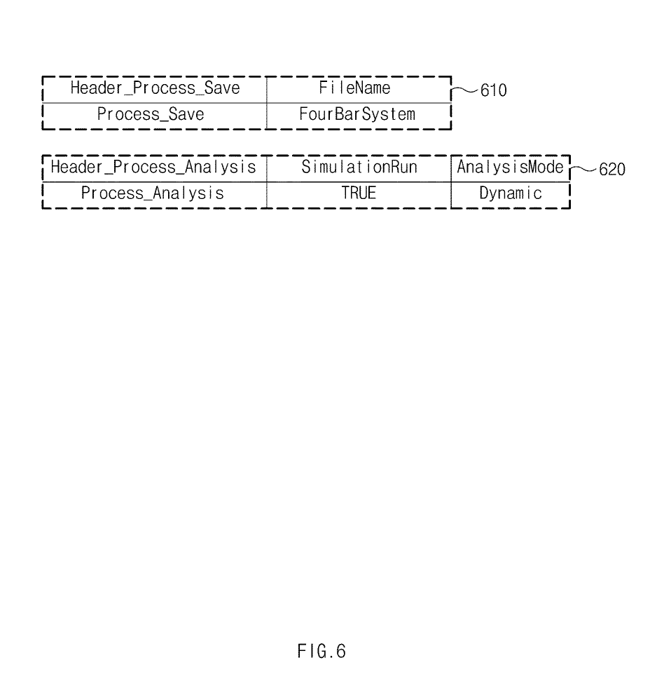

The sub data table 420 may define different parameter modification values of “Plain Tolerance Factor” in different rows. As mentioned above, a modeling program may perform a modeling as applying a modification value in the order from the top row to the bottom row of a data table. Additionally, according to the definition content of a function data table for defining a modeling performing method, a modeling may be performed repeatedly through a method of performing a modeling after modifying a first parameter value and then performing a modeling again after modifying the next parameter value. Through this, after defining values to be modified (or tested) in a data table, a user may sequentially check a modeling (or a simulation) implemented according to each result through one-time execution. A function data table is described with reference to FIG. 6.

According to an embodiment of the present disclosure, a computing device may modify a modeling as changing each plain tolerance factor to 3, 5, and 7 based on the sub data table 420. For example, when a plain tolerance factor value is 3, a computing device may simulate a corresponding first model 510 and then, continuously simulate a second model 520 where the plain tolerance factor value is 5 and a third model 530 where the plain tolerance factor value is 7 in order on the display of the computing device. A user may check a continuously-displayed modeling result and determine an appropriate plain tolerance factor.

FIG. 6 is a view illustrating a data table for providing an additional function to modeling modification according to an embodiment of the present disclosure.

Referring to FIG. 6, a spreadsheet may include a function data table, for example, a first function table 610 or a second function table 620 in addition to a data table for modifying a parameter. Such a function table may define an accompanying operation when a parameter is modified in a modeling. For example, the first function table 610 may modify a modeling based on a data table, and define an instruction for storing the modified modeling. For example, when a header for representing a save instruction (for example, Header_Process_Save) and a file name to be stored (for example, FourBarSystem) are specified, a computing device may modify a model based on a data table, for example, the data table 300 or the data table 400, and then store the modified model data by referring to the first function table 610. At this point, as a modified file name is set with a different name than an original file, it is possible to prevent data from overwriting the original during modification in a GUI environment.

As another example, the second function table 620 may define whether to execute an analysis mode and a simulation. For example, the second function table 620 may include a header filed for representing an analysis instruction (for example, Header_Process_Analysis), and include a simulation run field (for example, SimulationRun) and an analysis mode field (for example, AnalysisMode). After modifying some values of an original model, a computing device may perform a modeling according to the values defined in the second function table 620. For example, a computing device may analyze a model in a dynamic analysis mode or a static analysis mode, and execute a simulation.

In addition, various functions are defined as a function table. For example, a modeling result may be outputted continuously and repeatedly through a simulation for a predetermined number or until there is an additional input.

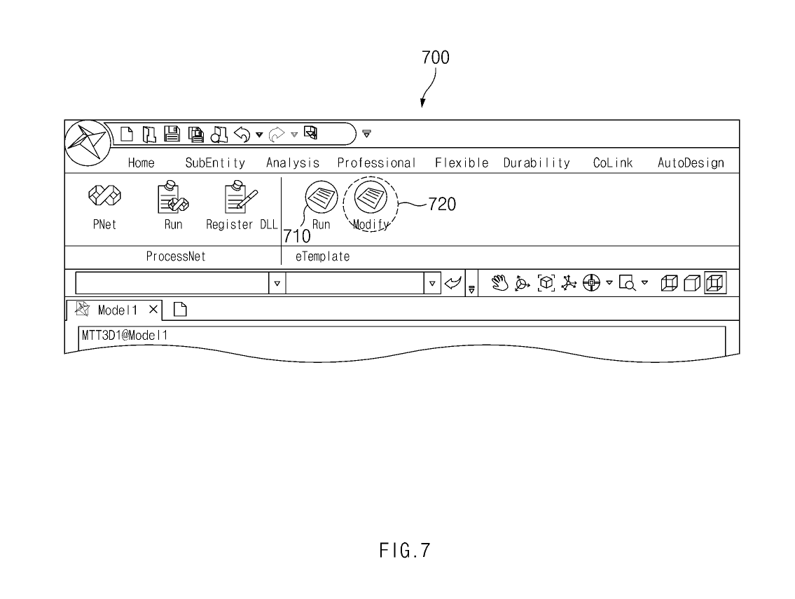

FIG. 7 is a view illustrating an exemplary modeling modification UI according to an embodiment of the present disclosure.

Referring to FIG. 7, a modeling modification UI may be provided together with a GUI of a modeling program. For example, when a modeling program supports a spreadsheet based modeling modification, a modeling modification item 720 may be provided as a button UI. A modeling creation item 710 may be used to create a modeling based on a spreadsheet.

For example, in a situation that a modeling performance result and a specific system model are loaded, when some parameters of a corresponding system model are to be modified, a user may select a modeling modification item 710 by using an input means (for example, a keyboard, a mouse, a touch input, and so on). When the modeling modification item 720 is selected, a UI for selecting a file where a data table for modification is stored may be provided on a pop-up window. When a file where a data table is stored is selected, a modeling program may extract a data table and a function data table in a corresponding file, and perform a modeling after modifying a parameter value of the system model defined in the data table. According to a function defined in the function data table, an operation such as storing a modified modeling, a simulation, and a repeated execution may be performed additionally.

FIG. 8 is a view illustrating a modeling modification process according to an embodiment of the present disclosure. Hereinafter, in the description relating to FIGS. 8 and 9, contents overlapping or corresponding to or similar to the above-mentioned contents may not be described.

In operation 810, a modeling program may be executed. For example, a computing device may have appropriate CAE software for modeling and execute corresponding software according to an execution instruction.

In operation 820, a first modeling may be performed based on a plurality of entities configuring a system. Herein, the first modeling may be understood as a modeling operation performed to create a model or modify a created model. The first modeling may be performed by an entity created in a GUI environment and a parameter value inputted with respect to an entity, and also may be performed by data extracted from a spreadsheet based data structure.

In operation 830, a header value, a parameter value, and a modification value that correspond to a header field, a parameter field, and a modification field respectively may be parsed from a data table including modification information for changing parameters of the model. The data table may include a modification value for changing at least one parameter value that at least one entity of the model has. That is, a first entity among a plurality of entities configuring a system model may include a first parameter and a first value corresponding to the first parameter. Herein, “the first entity” means an arbitrary entity but does not mean one entity. That is, the first entity may correspond to at least one entity. A computing device may check all entities (for example, a first entity) for changing a parameter value, a parameter (for example, a first parameter) to be changed in each entity, and a parameter value (for example, a modification value) to be changed, from a data table, and replace a first value with a modification value in operation 840.

In more detail, operation 830 may be performed including the following operation. For example, operation 830 may include receiving a selection input on a modification menu (for example, the modeling modification item 720) of a modeling program, determining a file including the data table, and obtaining the header value, the parameter value, and the modification value from the data table in the file.

In operation 840, the computing device may modify a parameter value of an entity based on a data table. At this point, the computing device may determine whether the obtained header value corresponds to a specified header value (for example, “Modify”), and when it is determined that the obtained header value corresponds to the specified header value, replace the first value with the modification value.

In operation 840, if the data table includes a sub data table defined by a modification value, the computing device may extract the sub data table, and modify the first value based on the extracted sub data table.

In operation 850, the computing device may perform a second modeling based on the modified entity. That is, the types and/or number of entities configuring a system model according to a first modeling result and a system model according to a second modeling result are identical to each other. However, the parameter values of the entities may be distinguished from each other.

When a function data table is obtained in operation 830, the computing device may perform the second modeling based on values defined in the function data table. For example, an operation such as storing a modeling performance result or repeatedly playing a simulation may be performed.

A process described with reference to FIG. 8 or methods described by referring to the drawings other than that may be stored in a computer readable instruction format on a recording medium. For example, according to an embodiment of the present disclosure, provided is a computer readable recording medium for storing an instruction. The instruction, when executed by a computing device, causes the computing device to execute a modeling program, perform a first modeling based on a plurality of entities by using the modeling program, wherein a first entity among the plurality of entities comprises a first parameter and a first value corresponding to the first parameter, parse a header value, a parameter value, and a modification value corresponding to each field from a data table comprising a header field, a parameter field, and a modification field; modify the first value of the first entity based on the extracted header value, parameter value, and modification value, and perform a second modeling based on the modified first entity.

FIG. 9 is a view illustrating an exemplary configuration of an electronic device for performing a modeling modification process according to an embodiment of the present disclosure.

FIG. 9 may be understood as an exemplary configuration of a computing device 900. The computing device 900, for example, may correspond to one of a personal computer (PC), a laptop, or a mobile computing device such as a tablet or a smartphone.

The electronic device 900 may include a processor 910, a memory 920, a communication interface 930, a display 940, and an input interface 950 (for example, a keyboard, a mouse, and so on). Such a configuration may be exemplary, and some components may be added or omitted within the scope that embodiments of the present disclosure implement. For example, the communication interface 930 may be omitted or hardware such as a microphone or a speaker may be added.

The processor 910 may correspond to at least one processor. For example, the processor 910 may include a central processing unit (CPU). Additionally or alternatively, the processor 910 may be implemented with an application processor (AP) or a graphical processing unit (GPU).

The processor 910 may implement a modeling engine 911. The modeling engine 911 may perform a function for extracting a data table from the memory 920 and providing necessary data to the modeling program 921. The modeling engine 911 may be implemented with software and operate by the processor 910.

The memory 920 may include the modeling program 921, for example, CAE software such as RecurDyn. Additionally, the memory 920 may include a mechanical modeling database for creation (MMDB_C) 923 for creating a modeling and an MMDB for modification (MMDB_M) 925. Both the MMDB_C 923 and the MMDB_M 925 may have an additional data table structure and accordingly, may be included in one file or one spreadsheet. The modeling engine 911 may distinguish data used for creation from data used for modification by recognizing the header of a data table and provide them to the modeling program 921.

It may be understood that the data table 300 and the data table 400 are included in or correspond to the MMDB_M 925. A model simulation performed by the modeling engine 911 may be outputted to the display 940, and may be stopped or repeated based on an input through the input interface 950.

The computing device 900 may perform the above-mentioned various modeling modification methods. Contents relating to this overlap the above-described contents and thus are omitted.

According to an embodiment of the present disclosure, only a parameter to be modified in a system model is selectively modified using a spreadsheet and a modeling may be performed.

Additionally, without considering the entire parameters of entities configuring a system, a modeling may be performed by repeating only a parameter that is a modification target.

What is claimed is:

1. A modeling method of a computing device comprising at least one processor, the method comprising:
executing a modeling program;
performing a first modeling based on a plurality of entities by using the modeling program, wherein a first entity among the plurality of entities comprises a first parameter and a first value corresponding to the first parameter;
parsing a header value, a parameter value, and a modification value corresponding to each field from a data table comprising a header field, a parameter field, and a modification field;
modifying the first value of the first entity based on the extracted header value, parameter value, and modification value; and
performing a second modeling based on the modified first entity.

2. The method of claim 1, wherein the modifying of the first value comprises, when, the extracted header value corresponds to a specified header value, replacing the first value with the modification value.

3. The method of claim 1, wherein the obtaining of the header value, the parameter value, and the modification value corresponding to the each field comprises:
receiving a selection input on a modification menu of the modeling program;
determining a file including the data table; and
obtaining the header value, the parameter value, and the modification value from the data table included in the file.

4. The method of claim 1, wherein the modifying of the first value comprises:
extracting a sub data table specified by the modification value; and
modifying the first value based on the sub data table.

5. The method of claim 1, wherein the performing of the second modeling comprises:
obtaining a function data table; and
performing the second modeling based on a value defined in the function data table.

6. The method of claim 1, wherein the data table further comprises an entity field, and the modifying of the first value comprises, when the first entity corresponds to a value of the entity field and the first parameter corresponds to a value of the parameter field, replacing the first value with the modification value.

7. The method of claim 1, wherein the data table comprises a plurality of columns corresponding to each field, and the modifying of the first value comprises replacing the first value in the order from a modification value in a top column to a modification value in a bottom column.

8. A computing device comprising:
at least one processor; and
a memory configured to store a modeling program,
wherein the at least one processor performs a first modeling based on a plurality of entities by using the modeling program, obtains a header value, a parameter value, and a modification value corresponding to each field from a data table comprising a header field, a parameter field, and a modification field, and performs a second modeling based on the plurality of entities and the obtained header value, parameter value, and modification value.

9. The computing device of claim 8, wherein the data table is included in a spreadsheet type of file stored in the memory.

10. A recording medium for storing computer readable instructions, wherein the instructions, when executed by a computing device, cause the computing device to execute a modeling program, perform a first modeling based on a plurality of entities by using the modeling program, wherein a first entity among the plurality of entities comprises a first parameter and a first value corresponding to the first parameter, parse a header value, a parameter value, and a modification value corresponding to each field from a data table comprising a header field, a parameter field, and a modification field; modify the first value of the first entity based on the extracted header value, parameter value, and modification value, and perform a second modeling based on the modified first entity.
